(19) United States
(12) Patent Application Publication
(10) Pub. No.: US 2025/0020936 A1
(43) Pub. Date: Jan. 16, 2025

(54) Adjustable Headbands

(71) Applicant: Apple Inc., Cupertino, CA (US)

(72) Inventor: Paul X Wang, Cupertino, CA (US)

(21) Appl. No.: 18/350,634

(22) Filed: Jul. 11, 2023

(51) Int. Cl. G02B 27/01

(52) U.S. Cl. CPC G02B 27/0176; G02B 2027/0154; G02B 2027/0161; G02B 2027/0169

(57) ABSTRACT

A head-mounted device may have a head-mounted housing containing rear-facing displays that display images for a user when the head-mounted housing is worn by the user. The head-mounted housing may be coupled to the user's head using an upper headband and a lower headband that are attached to a support member. The upper headband and/or the lower headband may rotate relative to the support member to adjust the position of the headband on the user's head. The adjustable headband may rotate about a friction hinge, in a recess of the support member, or about a rotating member of the support member. Additionally or alternatively, the adjustable headband may be coupled to an attachment on the support member that can slide along a portion of the support member. The adjustable headband may be further moved on the user's head by sliding the attachment on the support member.

### FIELD

This relates generally to headbands, and, more particularly, to adjustable headbands for electronic devices.

### BACKGROUND

Electronic devices such as head-mounted devices may have displays for displaying images. The displays may be housed in a head-mounted support structure.

### SUMMARY

A head-mounted device may have a head-mounted housing containing rear-facing displays that display images for a user when the head-mounted housing is worn by the user. The head-mounted housing may be coupled to the user's head using an upper headband and a lower headband coupled to the head-mounted housing using a support member.

The upper headband and/or the lower headband may rotate relative to the support member to adjust the position of the headband on the user's head. For example, the adjustable headband(s) may be movable between a front portion of the user's head and a rear portion of the user's head.

The adjustable headband(s) may rotate about a friction hinge, in a recess of the support member, or about a rotating member of the support member. The adjustable headband(s) may lock into multiple positions as the adjustable headband(s) are rotated relative to the support member.

Additionally or alternatively, the adjustable headband(s) may be coupled to an attachment on the support member that can slide along a portion of the support member. The adjustable headband(s) may be further moved on the user's head by sliding the attachment on the support member.

The adjustable headband may include a rigid portion that is coupled to the support member and a fabric portion that extends from the rigid portion. The fabric portion may include stiffeners embedded in the fabric.

### BRIEF DESCRIPTION OF THE DRAWINGS

FIGS. 1A-1C are side views of an illustrative electronic device such as a head-mounted display device with adjustable headbands in different positions on a user's head in accordance with some embodiments.

FIG. 2 is a side view of an illustrative adjustable headband coupled to a support member with a friction hinge and an intervening additional headband in accordance with some embodiments.

FIGS. 3A and 3B are front views of illustrative friction hinge portions have protrusions and recesses in accordance with some embodiments.

FIG. 4 is a side view of an illustrative adjustable headband coupled directly to a support member with a friction hinge in accordance with some embodiments.

FIG. 5 is a front view of an illustrative support member having a rotating member about which a headband may rotate in accordance with some embodiments.

FIG. 6 is a side view of an illustrative support member having a recess in which a headband may pivot in accordance with some embodiments.

FIG. 7 is a side view of an illustrative headband system having two headbands coupled to a support member in accordance with some embodiments.

FIG. 8 is a side view of an illustrative electronic device such as a head-mounted display device with an adjustable headband that is coupled to a sliding portion of a support member in accordance with some embodiments.

FIG. 9 is a front view of an illustrative headband having a rigid portion and a fabric portion with stiffeners in accordance with some embodiments.

FIG. 10 is a side view of an illustrative electronic device such as a head-mounted display device with headbands that rotate into a compact configuration in accordance with some embodiments.

### DETAILED DESCRIPTION

Head-mounted devices include head-mounted support structures that allow the devices to be worn on the heads of users. The head-mounted support structures may include device housings for housing components such as displays that are used for presenting a user with visual content. The head-mounted support structures for a head-mounted device may also include headbands and other structures that help hold a device housing on the face of a user. The headbands of a head-mounted device may be adjustable.

In some embodiments, it may be desirable to incorporate headbands that can contact the user's head in multiple locations while the head-mounted device is worn. The headbands may include a lower headband that is in contact with a portion of the back of the user's head and an upper headband. The upper and/or lower headbands may be adjustable. For example, the upper and/or lower headbands may pivot so that the upper and lower headbands can contact different portions of the user's head. In an illustrative example, the lower headband may contact a lower rear portion of the user's head, while the upper headband is movable between a front portion of the user's head (e.g., the user's forehead) and an upper rear portion of the user's head. To allow the upper and/or lower headbands to be adjusted in this way, the headbands may be attached to a head-mounted support structure via a pivoting structure, such as a friction hinge.

The friction hinge and/or the adjustable headband(s) may include tooth features or other features to provide mechanical haptics as the headband(s) are adjusted. Alternatively or additionally, the friction hinge and/or the adjustable headband(s) may include an encoder. The head-mounted device may receive signals from the encoder that reflect the position of the adjustable headband(s). In this way, the position of the adjustable headband(s) may be known when the adjustments are made.

The adjustable headband(s) may also be movable closer and farther from the front of the user's head. In particular, the pivot point around which the adjustable headband(s) rotate may slide forward and backward within the head-mounted support structure. By allowing for the adjustment of one or more headbands, the head-mounted device may be supported against the face of the user, while providing adjustments for user comfort and/or accommodations.

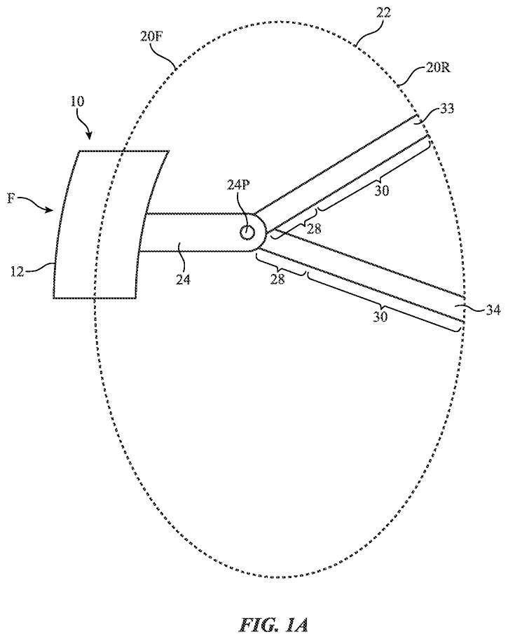

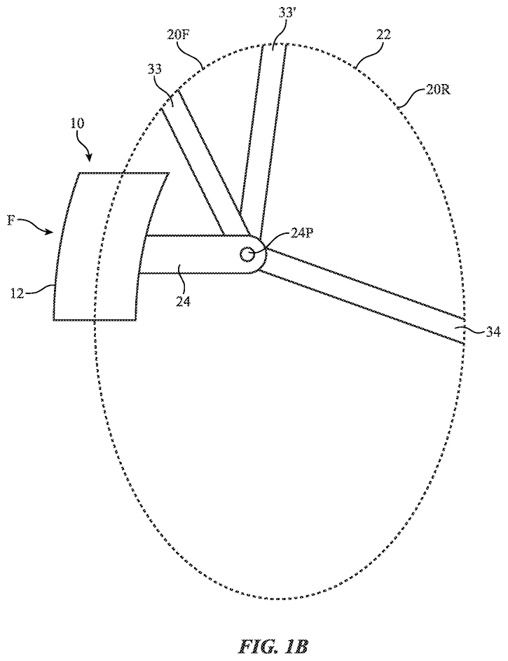

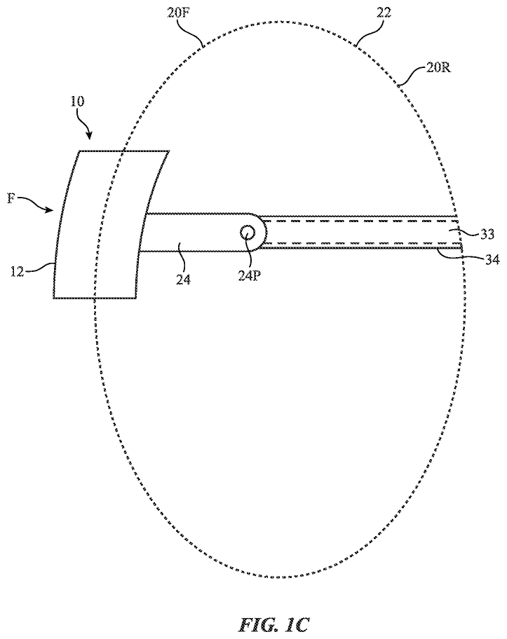

FIG. 1A is a side view of an illustrative head-mounted electronic device with one or more adjustable headbands. As shown in FIG. 1A, head-mounted device 10 may include head-mounted housing 12 (sometimes referred to as a main housing, main housing unit, or head-mounted support structure herein). Housing 12 may have walls or other structures that separate an interior housing region from an exterior region surrounding housing 12. For example, housing 12 may have walls formed from polymer, glass, metal, and/or other materials. Electrical and optical components may be mounted in housing 12. These components may include components such as integrated circuits, sensors, control circuitry, input-output devices, and/or other suitable components.

To present a user with images for viewing from eye boxes (e.g., eye boxes in which the user's eyes are located when device 10 is being worn on the users' head such as head 22 of FIG. 1A), device 10 may include displays and lenses. These components may be mounted in optical modules or other supporting structures in housing 12 to form respective left and right optical systems. There may be, for example, a left display for presenting an image through a left lens to a user's left eye in a left eye box and a right display for presenting an image to a user's right eye in a right eye box.

If desired, housing 12 may have forward-facing components such as cameras, other sensors, and/or a display on front F for gathering sensor measurements/other input and/or display information on front F. Housing 12 and may have a soft cushion on an opposing rear side of housing 12. The rear of housing 12 may have openings that allow the user to view images from the left and right optical systems (e.g., when the rear of housing 12 is resting on front surface 20F of the user's head 22).

Device 10 may have headbands 33 and 34, and may have other structures (e.g., an optional over-the-head strap) to help hold housing 12 on head 22. Headbands 33 and 34 may have first and second ends coupled, respectively, to the left and right sides of housing 12. In the example of FIG. 1A, coupling members 24 (also referred to as support members, support structures, and supports herein) which serve as extensions of housing 12 (e.g., extend from housing 12 directly or are attached directly to housing 12), are provided on the left and right sides of housing 12. Members 24 may be formed from rigid materials such as rigid polymer and/or other materials and may contain sensors, buttons, speakers, and other electrical components. Hinges, latches, and/or other mechanisms may be used to couple members 24 to housing 12 or members 24 may be formed as integral portions of a main housing unit. The ends of headband 33 and 34 may have coupling mechanisms such as openings configured to receive posts or other protrusions 24P on members 24 or other housing structures. These coupling mechanisms allow a user to removably attach headbands 33 and 34 to members 24 and thereby removably attach headbands 33 and 34 to housing 12. Members 24 may have elongated shapes of the type shown in FIG. 1A and/or other suitable shapes and may sometimes be referred to as rigid straps, rigid coupling members, or power straps.

Headbands 33 and 34 may have a soft flexible portion such as central portion 30. Portions 30 may be formed between two stiffer portions such as end portions 28 on the left and right ends of headbands 33 and 34. Portions 28 may be stiffened using embedded polymer stiffeners (e.g., single-layer or multilayer polymer stiffening strips) and/or other stiffening members.

Portions 30 may be formed from a stretchable material such as stretchy fabric. Portions 30 may, as an example, be formed from a band of flat knit fabric that includes stretchable strands of material (e.g., elastomeric strands) and/or which uses a stretchable fabric construction (e.g., a stretchable knit construction). Alternatively, portions 30 may be formed from a band of woven fabric, which may include stretchable strands of material and/or may use a stretchable fabric construction. Narrowed end portions of the band of knit fabric may, if desired, extend over stiffening members in end portions 28 (e.g., to ensure that headband 26 has a uniform external appearance).

The stretchability of headband portions 30 (and therefore headbands 33 and 34) allows headbands 33 and 34 to be stretched along their lengths. This allows the length of headbands 33 and 34 to be temporarily increased to help a user to place headbands 33 and 34 over the user's head when a user is donning device 10. When headbands 33 and 34 are released, the stretchiness and elastic nature of portions 30 of headbands 33 and 34 will help shorten headbands 33 and 34 and pull headbands 33 and 34 against the user's head.

Although not shown in FIG. 1A, the tension of headbands 33 and 34 to secure headbands 33 and 34 and device 10 on the user's head may be adjusted by tightening doubled-back portions of headbands 33 and 34. In particular, doubled-back portions of headbands 33 and 34 may pass through adjustment loops, and may have hook-and-loop fasteners on an inner surface, allowing the doubled-back portions to be secured to headbands 33 and 34. In this way, headbands 33 and 34 may be tightened or loosened as desired by a user of device 10.

In the illustrative example of FIG. 1A, headbands 33 and 34 may both contact rear portions of head 22. In particular, headband 33 may contact an upper rear portion of head 22 (e.g., in the upper half of the rear of head 22), while headband 34 may contact a lower rear portion of head 22 (e.g., in the lower half of the rear of head 22). By contacting the rear of head 22 in two different locations, headbands 33 and 34 may secure device 10 to head 22 while mitigating the amount of stress applied to head 22.

Although headbands 33 and 34 may support device 10 against the face of the user when in the positions shown in FIG. 1A, it may be desirable to adjust the position of one or both of headbands 33 and 34. For example, it may be desirable for headband 33 and/or headband 34 to contact different portions of the user's head to offload additional stress from device 10 and/or to provide additional comfort to the user. Illustrative examples of locations on the user's head to which headband 33 and/or headband 34 may be moved are shown in FIGS. 1B and 1C.

As shown in FIG. 1B, headband 33 may be moved to front portion 20F of user's head 22. For example, headband 33 may pivot around protrusions 24P (or otherwise pivot relative to members 24) from rear 20R to front 20F of head 22. In other words, headband 33 may be moved to a forehead of the user. Moving headband 33 to the forehead may reduce the amount of stress applied to rear 20R of head 22.

Alternatively, headband 33 may be moved to a top portion of head 22, as shown by location 33′. For example, headband 33 may pivot around protrusions 24P (or otherwise pivot relative to members 24) from rear 20R to the top of head 22.

The illustrative positions of headband 33 shown in FIG. 1B are merely illustrative. In general, headband 33 may be moved to any desired location of head 22. Additionally, although headband 34 is shown as remaining at the lower rear portion of head 22, headband 34 may also be adjustable (e.g., may pivot around protrusions 24P (or otherwise pivot relative to members 24). For example, as shown in FIG. 1C, headband 34 may be adjusted upward to a middle part of rear portion 20R of head 22, and headband 33 may be adjusted to the same position as headband 34. In other words, headbands 33 and 34 may overlap in the illustrative example of FIG. 1C.

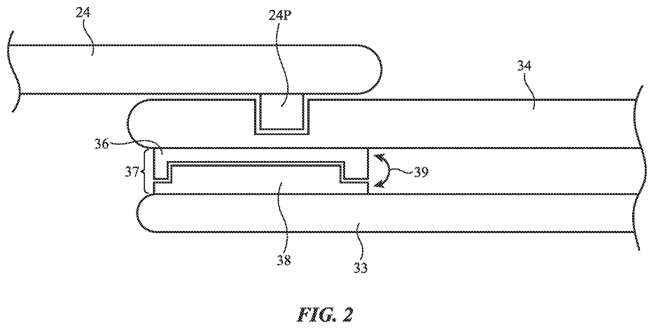

In the examples of FIGS. 1A-1C, headband 33 and/or headband 34 may pivot around protrusion 24P or otherwise pivot with respect to member 24. An illustrative example of a hinge that may be used to allow one or both headbands 33 and 34 to pivot is shown in FIG. 2.

As shown in FIG. 2, headband 34 may be coupled to member 24 via protrusion 24P. For example, protrusion 24P may be a post (such as a rectangular post with rounded corners or a post of another suitable shape) with one or more indented portions. Headband 34 may have a latch that engages with the indented portion of protrusion 24P, allowing headband 34 to be removably attached to member 24. However, this is merely illustrative. In general headband 34 may be attached to member 24 using any suitable attachment mechanisms, such as one or more posts, clasps, latches, snaps, etc. one protrusion 24P and/or headband 34.

Headband 33 may be coupled to headband 34 using friction hinge 37. In particular, friction hinge portion 36 may be coupled to headband 34, such as by molding friction hinge portion 36 to headband 34, adhesively attaching friction hinge portion 36 to headband 34, or otherwise attaching friction hinge portion 36 to headband 34. Similarly, friction hinge portion 38 may be coupled to headband 33, such as by molding friction hinge portion 38 to headband 33, adhesively attaching friction hinge portion 38 to headband 33, or otherwise attaching friction hinge portion 38 to headband 33. Friction hinge portions 36 and 38 may be formed from metal, plastic, and/or other suitable material(s).

Friction hinge portion 38 may be removably attached to friction hinge portion 36. For example, hinge portion 38 may be friction fit into friction hinge portion 36. In other words, the opening in friction hinge portion 36 may be just wide enough to accommodate friction hinge portion 38, so that when friction hinge portion 38 is pushed into the opening, friction hinge portion 38 remains removably attached to friction hinge portion 36. Alternatively or additionally, friction hinge portion 36 may have recesses and friction hinge portion 38 may have protrusions that engage with the recesses in friction hinge portion 36. In general, however, friction hinge portions 36 and 38 may be removably attached to each other in any suitable manner.

To adjust the position of headband 33 relative to member 24 (e.g., as shown in FIGS. 1A-1C), headband 33 may be rotated in directions 39. In particular, friction hinge portion 38 may rotate relative to friction hinge portion 36, and headband 33 may therefore rotate relative to headband 34 and member 24). In this way, the position of headband 33 on a user's head (e.g., head 22 of FIGS. 1A-1C) may be adjusted.

Although not shown in FIG. 2, headband 34 may also be adjustable relative to member 24 (e.g., may pivot relative to member 24). For example, protrusion 24P may be capable of rotating relative to member 24, or headband 34 may be able to pivot directly around protrusion 24P. Alternatively, a friction hinge, such as friction hinge 37, may be incorporated between member 24 and headband 34 to removably attach headband 34 to member 24, while allowing headband 34 to pivot/rotate relative to member 34. In this way, both headbands 33 and 34 may be adjustable, if desired.

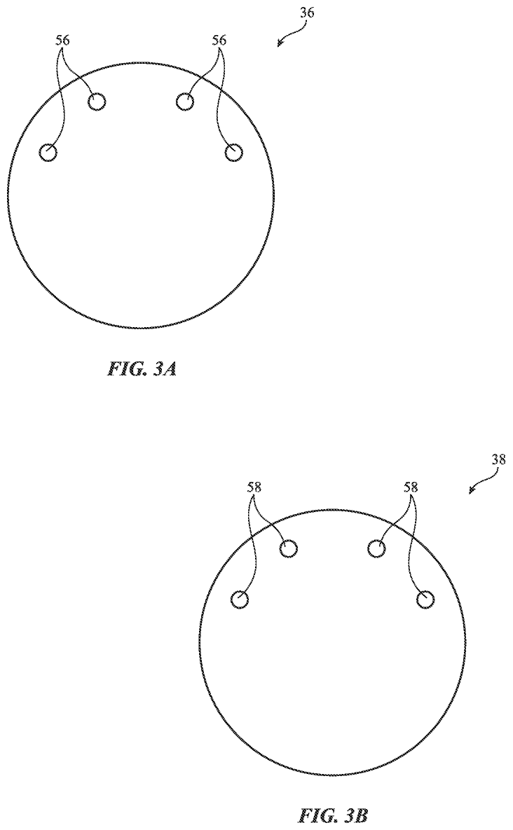

If desired, friction hinge 57 may include tooth features or other features that provide mechanical haptics. The tooth features may provide locations at which an adjustable headband may lock into place (e.g., require additional force to move further) with respect to member 24. An illustrative example of friction hinge portions with such features are shown in FIGS. 3A and 3B.

As shown in FIG. 3A, friction hinge portion 26 may include features 56. Features 56 may be teeth or protrusions (e.g., bumps), or may be recesses into which teeth or protrusions may enter. As shown in FIG. 3B, friction hinge portion 38 may include corresponding features 58. For example, if features 56 are teeth or protrusions, features 58 may be recesses into which the teeth or protrusions may enter and lock into place. Alternatively, if features 56 are recesses, features 58 may be teeth or protrusions.

By including features 56 and 58 on friction hinge portions 26 and 28, friction hinge 27 may have discrete locations at which friction hinge 27 will lock into place as headband 33 is rotated relative to member 24. The locations may correspond to the locations of headband 33 in FIGS. 1A-1C, as examples. In this way, a user may easily adjust the position of headband 33 relative to member 24.

The example of forming locking locations using teeth/protrusions and corresponding friction hinge portions is merely illustrative. In general, an adjustable headband may lock into place using any suitable mechanism. For example, a screw may be used to tighten the hinge around which the adjustable headband rotates to lock it into place, a secondary member may be clipped onto the hinge to lock the adjustable headband into place, or any other suitable mechanism may be used to lock the adjustable headband into place.

Although FIGS. 2 and 3 show friction hinge 37 between headbands 33 and 34, an additional friction hinge 37 may be formed between headband 34 and member 24, if desired. In this way, headband 34 may also rotate/pivot relative to member 24. If the features of FIGS. 3A and 3B are incorporated into the friction hinge between member 24 and headband 34, then headband 34 may lock into place at multiple locations relative to member 24.

In some embodiments, features 56 and/or 58 may alternatively or additionally include an encoder that is electrically connected to device 10. By including an encoder in friction hinge 27, device 10 may determine the position of the adjustable headband on the user's head. Device 10 may then alert a user to adjust the position of the headband. For example, device 10 may determine that there is an inadequate seal to the user's face, and may suggest adjusting the headband to a specific position to remedy the issue. Alternatively, device 10 may suggest adjusting the headband to provide a tighter or looser fit based on the information being displayed by device 10. For example, if a movie or video game is being displayed by device 10, device 10 may recommend tightening the headband. However, if other information, such as a webpage, is being displayed by device 10, device 10 may recommend loosening the headband to improve user comfort. However, these examples are merely illustrative. In general, device 10 may provide any suitable recommendation to a user regarding the position and/or fit of the adjustable headband.

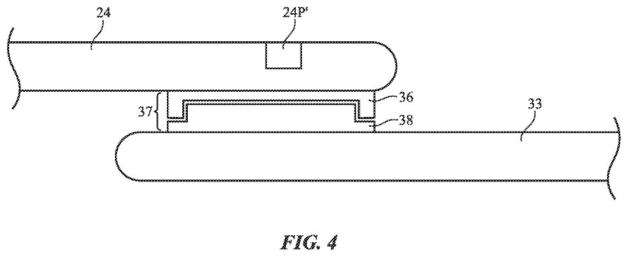

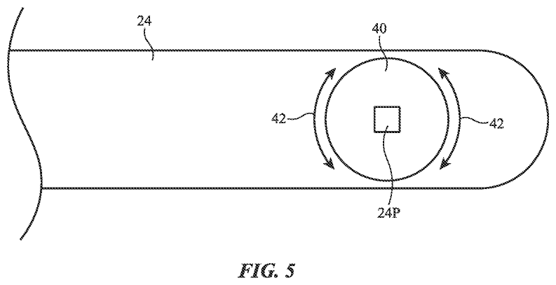

Moreover, although headband 33 is shown as attaching to headband 34 in FIG. 2, this arrangement is merely illustrative. If desired, headband 33 may be attached to member 24 and pivot relative to member 24. An illustrative example of an adjustable headband coupled to a head-mounted support member is shown in FIG. 4.

As shown in FIG. 4, friction hinge portion 36 may be formed on member 24, and friction hinge portion 38 may be formed on headband 33. Therefore, friction hinge 37 may couple headband 33 directly to member 24 and may allow headband 33 to rotate/pivot relative to member 24.

Member 24 may include optional recess 24P′ that may receive a post from another headband, such as headband 34, to removably couple the headband to member 24. Alternatively, headband 34 may be coupled to a lower surface of headband 33 (e.g., the opposite surface from friction hinge portion 38). If desired, a friction hinge may be formed between headband 33 and headband 34 to allow headband 34 to rotate/pivot relative to headband 33 and member 24.

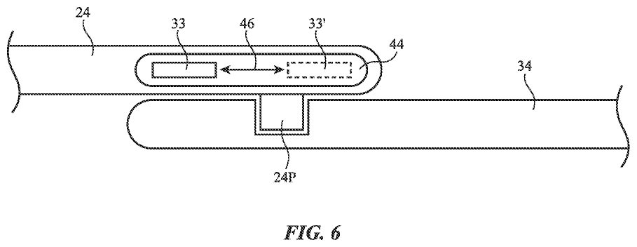

Although FIGS. 2-4 have described using a friction hinge to allow one or more headbands to attach to, and rotate relative to, member 24, this is merely illustrative. In general, any suitable mechanism may be used to allow one or more headbands to attach to, and rotate/pivot relative to, member 24. An illustrative example of an alternative pivoting mechanism is shown in FIG. 5.

As shown in FIG. 5, member 24 may include protrusion 24P. Headband 33 and/or headband 34 may attach to protrusion 24P. Additionally, member 24 may include rotating member 40, on which protrusion 24P may be mounted or otherwise attached. Rotating member 40 may be formed from plastic, metal, or other material, and may be formed in an opening in member 24. As an illustrative example, rotating member 40 may be a circular metal member that is formed in a circular opening or circular recess in member 24. The circular metal member may rotate within the opening/recess along directions 42. Therefore, a headband, such as headband 33 or 34 (FIGS. 1, 2, and 4), that is removably attached to member 24 at protrusion 24 (e.g., by a latch or other mechanism that engages with an opening or other feature of protrusion 24), may also rotate along directions 42. In this way, one or more headbands may be attached to protrusion 24 and may rotate relative to member 24. In an illustrative example, headband 34 (FIGS. 1-2) may be attached to member 24 at post 24P and may rotate relative to member 24 when rotating member 40 rotates. Headband 33 may then be coupled to headband 34 with a friction hinge (e.g., as shown in FIG. 2), allowing headband 33 to rotate relative to headband 34 and member 24. However, this arrangement is merely illustrative. In general, member 24, headband 33, and headband 34 may be coupled together in any suitable manner.

Although not shown in FIG. 5, rotating member 40 and/or the opening in member 24 in which rotating member 40 rotates may have features (such as tooth features and corresponding recesses), to allow rotating member 40 to lock into place at different locations as rotating member is rotated in the opening.

As an alternative to the friction hinges of FIGS. 2-4, and the circular rotating member of FIG. 5, an adjustable headband may be formed in a cavity of a support member and pivot within that cavity. An illustrative example is shown in FIG. 6.

As shown in FIG. 6, headband 34 may be removably attached to member 24 at protrusion 24P. Headband 34 may rotate/pivot relative to member 24, if desired, such as by incorporating a rotating member on which protrusion 24P is mounted (as in FIG. 5).

Member 24 may have opening or recess 44. Headband 33 may be coupled to member 24 within opening or recess 44. For example, headband 33 may be coupled to a pivoting member within opening/recess using a latch, snap, clasp, or other suitable mechanism. Headband 33 may pivot within recess 44 along direction 46 about the pivoting member in recess 44. In particular, as shown in FIG. 6, headband 33 may move from its original location at a leftmost edge of recess 44 to position 33′ at the rightmost edge of recess 44. If desired, headband 33 may be adjustable to any position between its original location and position 33′. In this way, headband 33 may be adjustable relative to member 24.

Although not shown in FIG. 6, opening 44, headband 33, and/or the pivoting member in opening 44 may have features (such as tooth features and corresponding recesses), to allow headband 33 to lock into place at different locations as headband 33 is pivoted within opening 44.

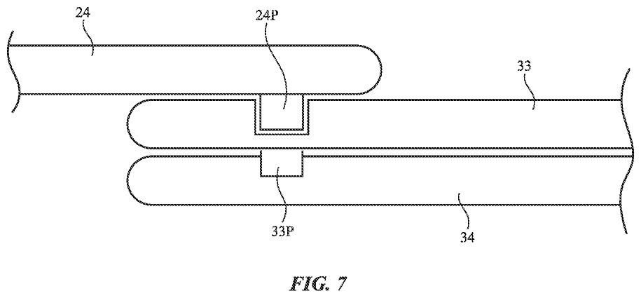

As another example, an upper adjustable headband may be coupled between a housing support member and a lower headband. An illustrative example is shown in FIG. 7.

As shown in FIG. 7, headband 33 may be removably attached to protrusion 24P of member 24, such as with a latch, snap, clasp, or other suitable mechanism. Headband 33 may rotate/pivot relative to member 24, if desired, such as by incorporating a rotating member on which protrusion 24P is mounted (as in FIG. 5).

Headband 33 may have protrusion 33P, which may have the same or different design as protrusion 24P. For example, protrusion 33P may be a rectangular protrusion with rounded edges (or any other suitable shape) and may have one or more indentations or other features to which a latch in headband 34 may be attached. Headband 34 may rotate/pivot relative to headband 33, if desired, such as by incorporating a rotating member on which protrusion 33P is mounted (as in FIG. 5).

The arrangement of FIG. 7 is merely illustrative. If desired, headband 34 may be directly coupled to member 24 at protrusion 24P, and headband 33 may be coupled to headband 34 at protrusion 33P. Headband 34 may then rotate/pivot relative to member 24, and/or headband 33 may rotate/pivot relative to headband 34, if desired, such as by incorporating a rotating member on which protrusion 24P and/or 33P is mounted (as in FIG. 5).

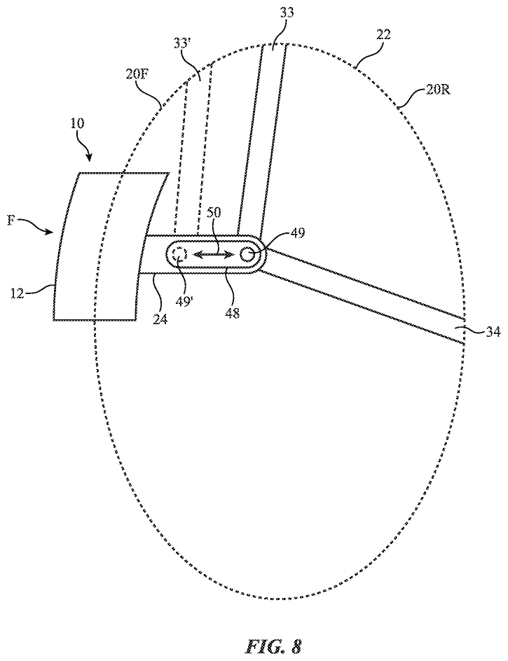

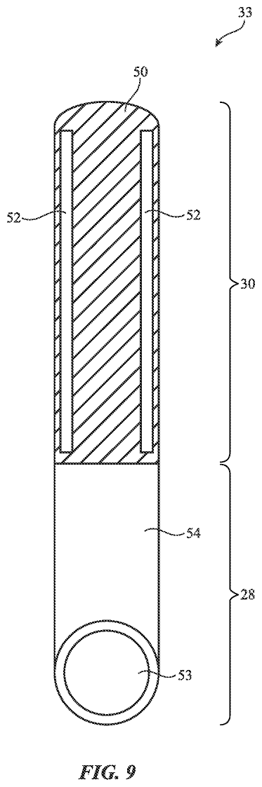

Instead of, or in addition to, allowing one or more headbands to rotate to different portions of a user's head, the headbands may be coupled to a support member portion with an adjustable position. An illustrative example is shown in FIG. 8.

As shown in FIG. 8, headbands 33 and 34 may be coupled to member 24 at attachment 49. Any of the attachment and/or rotational mechanisms described above in connection with FIGS. 1-7 may be used to attach headbands 33 and 34 to member 24 at attachment 49. Therefore, one or both of headbands 33 and 34 may rotate relative to member 24 about attachment 49, if desired.

Additionally, the position of attachment 49 (e.g., the position of attachment of headbands 33 and 34 on member 24) may be adjusted. In particular, member 24 may have opening 48 in which attachment 49 is mounted. Opening 48 may be, for example, an opening with a recessed portion, and attachment 49 may have protrusions that extend into the recessed portion to keep attachment 49 within opening 48. In an illustrative example, attachment 49 may include a circular metal member, such as member 40 of FIG. 5, that can slide within opening 48. Attachment 49 may also include a protrusion, such as protrusion 24P of FIGS. 1-7, to which headband 33 and/or headband 34 may be attached.

Attachment 49 may be slidably moved in directions 50. For example, attachment 49 may be moved between its original position (at the rightmost edge of opening 48 in FIG. 8) to position 49′ (at the leftmost edge of opening 48 in FIG. 8). In the illustrative example of FIG. 8, headband 33 may be in its original position on the upper portion of head 22 when attachment 49 it its original position, and may be at position 33′ on the upper front 20F of head 22 when attachment 49 is at position 49′. Headband 34 may stretch to accommodate the movement of attachment 49, or headband 34 may be attached to member 24 at a location separate from attachment 49. In this way, the position of headband 33 on head 22 may be adjusted by sliding attachment 49 within opening 48 and/or by rotating/pivoting headband 33 relative to member 24.

Although not shown in FIG. 8, opening 48 and/or attachment 49 may have features (such as tooth features and corresponding recesses), to allow attachment 49 to lock into place at different locations as attachment 49 is moved within opening 48.

Regardless of the attachment and/or rotational mechanism with which an adjustable headband is attached to a housing member, the adjustable headband may include reinforced portions. An illustrative example of an adjustable headband is shown in FIG. 9.

As shown in FIG. 9, adjustable headband 33 may include portions 28 and 30. Portion 28 may be a stiff portion formed from rigid material 54, such as plastic or metal, and/or may include fabric that covers rigid material. Portion 30 may also include attachment portion 53, which may removably attach headband 33 to a housing support member (such as member 24). Attachment portion 53 may be a portion of a friction hinge, an opening with a latch to attach to a protrusion on a support member, or any other suitable attachment mechanism. By forming portion 28 from a rigid or semi-rigid material, headband 33 may remain supported off of the head near attachment portion 53. In this way, it may be easier for a user to don headband 33.

Portion 30 may be a soft portion, such as a woven or knit portion formed from fabric 50. If desired, stiffeners 52 may optionally be included in fabric 50. Stiffeners 52 may be formed from a cord, such as a braided cord, or a flexible strip of polymer (e.g., an elastomer such as thermoplastic polyurethane). Stiffeners 52 may be sufficiently flexible to permit the headband to bend and twist, but may not stretch substantially along its length and may therefore sometimes be referred to as a non-stretchable stiffener, non-stretchable member, non-stretchable stiffening structure, etc. Stiffeners 52 may be significantly less stretchy and soft than fabric 50 and may serve to increase the stiffness and decrease (or eliminate) stretchiness at desired portions along headband 33. At the same time, the flexibility of stiffeners 52 may allow headband 33 to bend around the curvature of a user's head. Stiffeners 52 may be inserted into selected portions of headband 33 to selectively stiffen headband 33 at desired portions along its length, if desired.

However, the use of fabric 50 to form portion 30 of headband 33 is merely illustrative. Portion 30 may be formed from a rigid material, such as plastic, metal, or other material, and may include a cushion or pad on the rigid material to rest on the user's head and provide additional comfort. By forming portion 30 from rigid material (or by incorporating stiffeners 52 into fabric 50), it may be easier to rotate/pivot or otherwise adjust headband 33 relative to a housing support member.

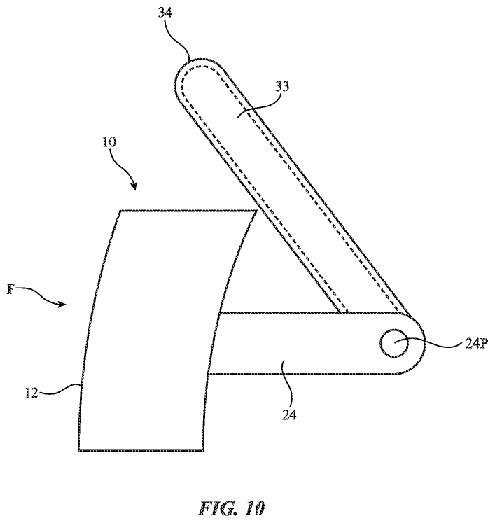

In addition to providing comfort and adjustability when a head-mounted device is worn, the use of one or more adjustable headbands may allow for more compact storage and easier donning of the device and headbands. An illustrative example is shown in FIG. 10.

As shown in FIG. 10, headbands 33 and 34 may be rotated/pivoted to fold up against device 10 when device 10 is not in use (e.g., not on the user's head). This arrangement may allow device 10 and the headbands to be stored more compactly.

Additionally, by adjusting headbands 33 and 34 to be against device 10, a user may don device 10 by first putting their face against device 10 and then rotating headbands 33 and 34 over their head and into their desired positions (e.g., the positions in FIGS. 1A-1C). In some embodiments, for example, rotating headbands 33 and 34 may remain at a fixed position relative to one another (e.g., overlapping) until rotating headbands 33 and 34 reach a certain point of the user's head, such as the upper rear portion that headband 33 is located in FIG. 1A. Then, further pulling on headband 34 may move headband 34 to a different location, such as the lower rear portion that headband 34 is located in FIG. 1A. Any suitable mechanism may be used to lock headbands 33 and 34 together during their additional movement, such as the locking friction hinge features of FIGS. 3A and 3B. In this way, the movement of headbands 33 and 34 may allow for compact storage and for easier donning of device 10.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A head-mounted device support structure configured to couple to a head-mounted device housing, the head-mounted device support structure comprising:
a support member;
a first headband removably attached to the support member; and
a second headband removably attached to the support member, wherein
the second headband is configured to rotate relative to the support member.

2. The head-mounted device support structure of claim 1, wherein the support member comprises a protrusion, and the first headband is attached to the support member at the protrusion.

3. The head-mounted device support structure of claim 2, wherein the first headband comprises a first friction hinge portion, and the second headband comprises a second friction hinge portion that is configured to engage the first friction hinge portion to removably attach the second headband to the first headband.

4. The head-mounted device support structure of claim 3, wherein the first and second friction hinge portions form a friction hinge, and the second headband is configured to rotate relative to the support member about the friction hinge.

5. The head-mounted device support structure of claim 4, wherein the friction hinge comprises recesses and protruding features that fit into the recesses at given locations, and the friction hinge is configured to lock into place at the given locations.

6. The head-mounted device support structure of claim 3, wherein the support member further comprises a rotating member, the protrusion is mounted on the rotating member, and the first headband is configured to rotate relative to the support member when the rotating member rotates.

7. The head-mounted device support structure of claim 1, wherein the support member comprises a first friction hinge portion, and the second headband comprises a second friction hinge portion that is configured to engage the first friction hinge portion to removably attach the second headband to the support member.

8. The head-mounted device support structure of claim 1, wherein the support member comprises a recess and a pivoting member in the recess, the second headband is coupled to the pivoting member, and the second headband is configured to rotate relative to the support member as the pivoting member pivots in the recess.

9. The head-mounted device support structure of claim 1, wherein the first headband is configured to rotate relative to the support member.

10. The head-mounted device support structure of claim 1, wherein the support member comprises an attachment in an opening, the second headband is configured to attach to the support member at the attachment, and the attachment is configured to slide within the opening.

11. The head-mounted device support structure of claim 1, wherein the second headband comprises a rigid portion and a fabric portion, and the rigid portion is configured to be attached to the support member.

12. The head-mounted device support structure of claim 11, wherein the second headband further comprises a stiffener in the fabric portion.

13. The head-mounted device support structure of claim 1, wherein the second headband comprises rigid material.

14. A head-mounted device headband system operable with a head-mounted device support structure, the head-mounted device headband system comprising:
a first headband configured to be coupled to the head-mounted device support structure; and
a second headband configured to be coupled to the head-mounted device support structure, wherein the second headband is further configured to rotate relative to the head-mounted device support structure.

15. The head-mounted device headband system of claim 14, wherein the second headband is configured to be coupled to the head-mounted device support structure at a friction hinge, and the second headband is configured to rotate relative to the head-mounted device support structure about the friction hinge.

16. The head-mounted device headband system of claim 14, wherein the second headband is configured to be coupled to the head-mounted device support structure at a given portion of the head-mounted device support structure that rotates, and the second headband is configured to rotate relative to the head-mounted device support structure about the given portion.

17. The head-mounted device headband system of claim 14, wherein the second headband is configured to be coupled to the head-mounted support structure in a recess of the head-mounted support structure, and the second headband is configured to rotate relative to the head-mounted device support structure by pivoting in the recess.

18. The head-mounted device headband system of claim 14, wherein the second headband is configured to be coupled to the head-mounted support structure at a slidable portion of the head-mounted support structure, and the second headband is further configured to move relative to the head-mounted support structure when the slidable portion moves.

19. A head-mounted device support structure configured to couple to a head-mounted device housing, the head-mounted device support structure comprising:
a support comprising a protrusion;
a first headband coupled to the protrusion;
a second headband; and
a friction hinge between the first headband and the second headband that couples the first headband to the second headband, wherein the second headband is configured to rotate relative to the support about the friction hinge.

20. The head-mounted devices support structure of claim 19, wherein the second headband is configured to rotate between a forward position and a rearward position.

21. The head-mounted device support structure of claim 20, wherein the second headband is configured to lock in at least one additional position between the forward position and the rearward position.
